(19) United States
(12) Patent Application Publication
(10) Pub. No.: US 2006/0221903 A1
(43) Pub. Date: Oct. 5, 2006

(54) Communication connection control mechanism in a core network ordered access change scenario

(75) Inventors: Kari Kauranen, Helsinki (FI); Uwe Schwarz, Veikkola (FI); Jarmo Virtanen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/181,792

(22) Filed: Jul. 15, 2005

(30) Foreign Application Priority Data
Mar. 30, 2005 (EP) EP 05 006 890.7

(51) Int. Cl. H04Q 7/00; H04L 12/56

(52) U.S. Cl. 370/331; 370/401

(57) ABSTRACT

There is proposed a mechanism for controlling a communication connection of a user equipment in a communication network. The communication network comprises at least a core network subsystem having at least one core network control element, and a first access network subsystem and at least a second access network subsystem. On one hand, when it is detected that at least one connection parameter of a communication connection of the user equipment can not be maintained by the first access network subsystem, a connection modification message is sent to the core network control element. The core network control element responds with an acknowledgement message the acknowledgement message comprising an instruction parameter for instructing that the communication connection of the user equipment is to be changed to the second access network subsystem being determined to having the capability to provide the connection parameter. On the other hand, when a change of a communication connection of the user equipment from the first access network subsystem to the second access network subsystem is to be performed, it is checked whether or not the cell change is executable. On the basis of the result of the checking step, a message is sent to the core network control element comprising an information element about the execution of the change of the access network subsystem.

### BACKGROUND OF THE INVENTION

1. Field of the Invention

The present invention relates to a method and corresponding system for controlling a communication connection of a user equipment in a communication connection in case of an ordered change of access networks, a corresponding core network control element and a corresponding access network subsystem element. In particular, the present invention relates to a communication connection control mechanism in a core network ordered access change scenario.

For the purpose of the present invention to be described herein below, it should be noted that

a communication device or user equipment may for example be any device by means of which a user may access a communication network; this implies mobile as well as non-mobile devices and networks, independent of the technology platform on which they are based; only as an example, it is noted that terminals and network nodes operated according to principles standardized by the 3^{rd} Generation Partnership Project 3GPP and known for example as UMTS terminals as well as terminals and network elements used in 2nd generation (2G) networks are particularly suitable for being used in connection with the present invention;

a communication device can act as a client entity or as a server entity in terms of the present invention, or may even have both functionalities integrated therein;

contents to be transferred by a communication connection as used in the present invention may comprise at least one of audio data, video data, image data, text data, and meta data descriptive of attributes of the audio, video, image and/or text data, any combination thereof or even, alternatively or additionally, other data such as, as a further example, program code of an application program to be accessed/downloaded;

method steps likely to be implemented as software code portions and being run using a processor at one of the server/client entities are software code independent and can be specified using any known or future developed programming language;

method steps and/or devices likely to be implemented as hardware components at one of the server/client entities are hardware independent and can be implemented using any known or future developed hardware technology or any hybrids of these, such as MOS, CMOS, BiCMOS, ECL, TTL, etc, using for example ASIC components or DSP components, as an example;

generally, any method step is suitable to be implemented as software or by hardware without changing the idea of the present invention;

devices or elements can be implemented as individual devices, but this does not exclude that they are implemented in a distributed fashion throughout the system, as long as the functionality of the device or element is preserved.

2. Related Prior Art

In the last years, an increasingly extension of communication networks, e.g. of wire based communication networks, such as the Integrated Services Digital Network (ISDN), or wireless communication networks, such as the cdma2000 (code division multiple access) system, cellular 3rd generation (3G) communication networks like the Universal Mobile Telecommunications System (UMTS), cellular 2nd generation (2G) communication networks like the Global System for Mobile communications (GSM), the General Packet Radio System (GPRS), the Enhanced Data Rates for Global Evolutions (EDGE), or other wireless communication system, such as the Wireless Local Area Network (WLAN), took place all over the world. Various organizations, such as the 3^{rd} Generation Partnership Project (3GPP), the International Telecommunication Union (ITU), 3^{rd} Generation Partnership Project 2 (3GPP2), Internet Engineering Task Force (IETF), and the like are working on standards for telecommunication network and multiple access environments.

In general, the system structure of a communication network is such that one party, e.g. a subscriber's user equipment, such as a mobile station, a mobile phone, a fixed phone, a personal computer (PC), a laptop, a personal digital assistant (PDA) or the like, is connected via transceivers and interfaces, such as an air interface, a wired interface or the like, to an access network subsystem. The access network subsystem controls the communication connection to and from the user equipment and is connected via an interface to a corresponding core or backbone network subsystem. The core (or backbone) network subsystem switches the data transmitted via the communication connection to a destination party, such as another user equipment, a service provider (server/proxy), or another communication network. It is to be noted that the core network subsystem may be connected to a plurality of access network subsystems. Depending on the used communication network, the actual network structure may vary, as known for those skilled in the art and defined in respective specifications, for example, for UMTS, GSM and the like.

Generally, for properly establishing and handling a communication connection between network elements such as the user equipment and another user terminal, a database, a server, etc., one or more intermediate network elements such as control network elements, support nodes or service nodes are involved.

Wireless communication networks can be divided into circuit switched networks and packet switched networks. In packet switched networks, the transmission medium is common to all users.

The GPRS system represents an example of a packet switched network structure which is used in 2G communication networks. The basic structure of a GPRS network comprises at least one Serving GPRS Support Node (SGSN), at least one Gateway GPRS Support Node (GGSN) and at least one Base Station Subsystem (BSS) connected to a corresponding SGSN and comprising a Base Station Controller (BSC) and Base Transceiver Stations (BTSs) forming so-called cells. It is to be noted that also other network elements are involved in the GPRS but these are commonly known to those skilled in the art and not necessary for describing the present invention so that a detailed description thereof is omitted.

Basically, when a mobile station or user equipment (UE) is located in a cell of a 2G cellular access network subsystem, every packet directed to or from the UE is transmitted through a BTS, a BSC, a SGSN and a GGSN. The UE is located in its cell and communicates with the BTS through a radio interface, for example. The link between the UE and the SGSN is uniquely identified by a routeing area and a temporary logical link identity. The routeing area may comprise several cells (or BTS), and is used in the GPRS mobility management as location information for mobiles in a so-called stand-by-state in which the mobile has no active connections. It is to be noted that depending on the equipment level of the BTS, there may be cells offering a higher or lower service and/or connection quality level within one routeing area.

During a transmission via an active connection, the application layer in the MS sends a PDP PDU (Packet Data Protocol Packet Data Unit) which can be, e.g., an IP Packet. The PDU is encapsulated and transmitted between the BSC and the SGSN by the Base Station Subsystem GPRS Protocol (BSSGP). For downlink packets, the BSS checks the cell identity indicated in a BSSGP header, and routes the cells to the appropriate BTS. For uplink packets, the BSC adds to the BSSGP header a cell identity of the MS based on the source BTS. Between the SSGN and the GGSN, the link is identified by the SGSN and GGSN addresses and a tunnel identifier (TID) which identifies the connection in the GGSN and in the SGSN. On the link between the SGSN and the GGSN, a GPRS Tunneling Protocol (GTP) is used. More details regarding the signalling procedures and functionalities between a BSS and a SGSN for control of GSM packet data services are described in the 3GPP specification TS 48.018 V6.6.0.

A further development in the field of wireless communication networks is the introduction of EDGE systems. EDGE is a radio signalling technology for 3G mobile networks. It boosts data transfer rates and volumes on existing GSM/GPRS networks by significantly increasing data transfer speeds. For providing EDGE functionality, the communication networks, in particular the access network subsystems, must be upgraded by installing respective elements which increases the costs of the network and is thus not available throughout the complete network environment.

In 3G cellular networks, like a Universal Mobile Telecommunications System (UMTS) network, there are some differences with respect to 2G networks. Most of these changes are in the way users access the network and its control, now called the radio access network (RAN). The most fundamental change is the air interface. Wideband Code Division Multiple Access (WCDMA) has been chosen as the air interface because of its increased bit rate capabilities and efficiency. This change also represents a large cost for the network operator, as new BTSs will have to be employed, and deployed in the network. Therefore, in the beginning, the 3G components will be used to complement the GSM network. Its deployment will mainly be in highly urbanised areas, with GSM still providing service for rural areas.

In order to handle the change to the 3G system, however, the core network elements and some mobile terminals will be able to handle both 2G and 3G subscribers. An example of the reason for this need is in the security mechanisms used during connection set up. These mechanisms differ in GSM and 3G and therefore these core network elements will need to handle both types.

Although the packet core network is evolved from the GPRS packet network, the network will require a new different SGSN, the 3G SGSN. There are some functionality differences in the 3G-SGSN to that of the 2G-SGSN especially in terms of mobility management. In large part, this is due to the introduction of the RNC in the RAN, which will take over some of the mobility management functions, allowing soft handovers that are no longer visible to the packet switched core network. In order to allow inter operability between the UMTS and GSM systems, it is necessary to allow inter-system handovers (ISHO), where the radio access (i.e. the access network subsystem) changes between GSM and WCDMA during a transaction. Therefore, in the GSM air interface, it has been enabled to transmit broadcast system information about WCDMA in the downlink direction and vice versa.

However, presently, when a 2G/3G subscriber with a corresponding dual mode user equipment wishes to activate a PDP context with a service level or connection quality parameters (Quality of Service, QoS) which the 2G cannot provide, the 2G-SGSN can either accept the PDP activation request but downgrade the QoS for the 2G access, or reject the request (call blocking). Then, an inter-system cell change towards a 3G access network can be initiated, after which the QoS can be upgraded again to the level originally requested. However, this procedure is time expensive and requires signalling and processing capacity in the network elements. Moreover, the subscriber has to suffer from low-quality access. Alternatively, the end-user application may not accept the downgraded QoS at all and, thus, reject the connection. Another scenario is, for example, that the service could be provided in the 2G network but the operator still prefers the 3G system for specific services. Also in such cases the desired inter-system cell change might not succeed but the SGSN is not properly informed.

In document US 2004/0114615 of the present applicant a method and system for providing access to a core network via at least a first and a second access network is described. This mechanism is usable in case of a network ordered change of an access network when a first access network can not offer or is not willing to offer a required service level for a communication connection. The mechanism described is executed in the call set-up phase.

Another problem is encountered in conventional communication networks in case a access network change is ordered. When the 2G SGSN has ordered (or recommended) the access network change to the BSC the further processing is decoupled from the core network side's control. For example, according to 3GPP TS 48.018, when the change is ordered by the core network by signalling it to the BSS, the signalling is normally replied with an acknowledgment message. Such acknowledgement messages may also cause a PDP context modification procedure by the 2G SGSN which however is not necessary if the UE moves to the 3G domain. Hence, processing and signalling load in the network is increased without need.

On the other hand, if the access network change is ordered by the 2G SGSN but the change is not executable another problem may occur. The reason is that the 2G SGSN is not aware whether or not the UE is the coverage area of a 3G access network. Hence, the following situation is possible. The UE requests a streaming call with, for example, 128 kbps in 2G GPRS network environment. The 2G-SGSN recognizes that it can not support the request. Hence, the SGSN does not reply to the service request and the UE keeps waiting for the response on the request. Instead the 2G SGSN recommends to the BSC a cell change to a 3G network cell which is assumed to be able to offer the requested service level. Alternatively, the 2G-SGSN may also reply in any manner to the request but commands at the same time the inter-system cell change to the 3G network. However, the BSC knows, for example from neighbour cell measurements, that the mobile is not in a 3G coverage area. Therefore, the BSC is not able to follow the order and does nothing further. On the other hand, the 2G SGSN assumes cell change happened to 3G. After an expiration timer of e.g. 30 seconds the UE re-sends the 128 kbps request to SGSN, and the sequence described above starts again. This may result in a seamless endless loop which costs resources and means a reason of discomfort for the user.

### SUMMARY OF THE INVENTION

Thus, it is an object of the invention to provide an improved communication connection control mechanism for a communication connection of a user equipment in a communication network when an inter-system handover is ordered.

In particular, it is an object of the invention to provide a mechanism by means of which a service level downgrade of the communication connection can be avoided and the signaling and processing load in the network can be reduced.

This object is achieved by the measures defined in the attached claims.

In particular, according to one aspect of the proposed solution, there is provided, for example, a method of controlling a communication connection of a user equipment in a communication network, wherein the communication network comprises at least a core network subsystem having at least one core network control element, and a first access network subsystem and at least a second access network subsystem, the method comprising steps of detecting that at least one connection parameter of a communication connection of the user equipment can not be maintained by the first access network subsystem or is not intended to be maintained for the communication connection, sending a connection modification message indicating the result of the detecting step from the first access network subsystem to the core network control element, transmitting an acknowledgement message in response to the connection modification message from the core network control element to the access network subsystem, wherein the acknowledgement message comprises an instruction parameter for instructing that the communication connection of the user equipment is to be changed to the second access network subsystem being determined to having the capability to provide the connection parameter.

Furthermore, according to one aspect of the proposed solution, there is provided, for example, a system for controlling a communication connection of a user equipment in a communication network, wherein the communication network comprises at least a core network subsystem having at least one core network control element, and a first access network subsystem and at least a second access network subsystem, the system comprising detecting means for detecting that at least one connection parameter of a communication connection of the user equipment can not be maintained by the first access network subsystem or is not intended to be maintained for the communication connection, sending means for sending a connection modification message indicating the result of the detecting means from the first access network subsystem to the core network control element, transmitting means for transmitting an acknowledgement message in response to the connection modification message from the core network control element to the access network subsystem, wherein the transmitting means introduces into the acknowledgement message an instruction parameter for instructing that the communication connection of the user equipment is to be changed to the second access network subsystem being determined to having the capability to provide the connection parameter.

Moreover, according to one aspect of the proposed solution, there is provided, for example, a core network control element usable for controlling a communication connection of a user equipment in a communication network, wherein the communication network comprises at least a core network subsystem having at least the core network control element, and a first access network subsystem and at least a second access network subsystem, the core network control element comprising a processor configured to receive and process a connection modification message indicating that at least one connection parameter of a communication connection of the user equipment can not be maintained by the first access network subsystem or is not intended to be maintained for the communication connection, the processor being further configured to generate and transmit to the first access network subsystem an acknowledgement message in response to the connection modification message, wherein the processor introduces in the acknowledgement message an instruction parameter for instructing that the communication connection of the user equipment is to be changed to the second access network subsystem being determined to having the capability to provide the connection parameter.

According to further refinements, the proposed solution may comprise one or more of the following features:

a determination may be executed in the core network control element on the basis of the connection modification message that the connection parameter can be provided by the second access network subsystem;

upon the receipt of the acknowledgement message an instruction message may be sent from the first access network subsystem to the user equipment to execute a change to the second access network subsystem, and an inter-system handover may be performed by requesting an establishment of a communication connection including the connection parameter at the second access network subsystem;

the connection parameter may be a quality of service parameter;

the instruction parameter may be a cell change order parameter;

the second access network subsystem may be of a later generation as the first access network subsystem, in particular may the first access network subsystem be of a second generation cellular network type and the second access network subsystem may be of a third generation cellular network type;

the core network control element may be a service GPRS support node;

the connection parameter of the communication connection of the user equipment may be requested and/or granted in a first cell section of the first access network subsystem, which cell section may offer different connection capabilities than another cell section of the first access network subsystem to which the user equipment is moving;

then, the first cell section of the first access network subsystem may comprise an EDGE capability and the second access network subsystem comprises WCDMA capability.

the core network control element may be informed about the execution of a user equipment's change to the second access network subsystem.

Additionally, according to one aspect of the proposed solution, there is provided, for example, a method of controlling a communication connection of a user equipment in a communication network, wherein the communication network comprises at least a core network subsystem having at least one core network control element, and a first access network subsystem and at least a second access network subsystem, the method comprising steps of determining that a change of a communication connection of the user equipment from the first access network subsystem to the second access network subsystem is to be performed, checking whether or not the change of the communication connection of the user equipment from the first access network subsystem to the second access network subsystem is executable, sending, on the basis of the result of the checking step, a message to the core network control element comprising an information element about the execution of the change of the access network subsystem.

Furthermore, according to one aspect of the proposed solution, there is provided, for example, a system of controlling a communication connection of a user equipment in a communication network, wherein the communication network comprises at least a core network subsystem having at least one core network control element, and a first access network subsystem and at least a second access network subsystem, the system comprising means in the first access network subsystem for determining that a change of a communication connection of the user equipment from the first access network subsystem to the second access network subsystem is to be performed, means in the first access network subsystem for checking whether or not the change of the communication connection of the user equipment from the first access network subsystem to the second access network subsystem is executable, means in the first access network subsystem for sending, on the basis of the result of the means for checking, a message to the core network control element comprising an information element about the execution of the change of the access network subsystem.

Moreover, according to one aspect of the proposed solution, there is provided, for example, an access network subsystem element usable in controlling a communication connection of a user equipment in a communication network, wherein the communication network comprises at least a core network subsystem having at least one core network control element, and a first access network subsystem comprising the access network subsystem element and at least a second access network subsystem, the access network subsystem element comprising a processor configured to determine that a change of a communication connection of the user equipment from the first access network subsystem to the second access network subsystem is to be performed, to check whether or not the change of the communication connection of the user equipment from the first access network subsystem to the second access network subsystem is executable, and to send, on the basis of the result of the check, a message to the core network control element comprising an information element about the execution of the change of the access network subsystem.

According to additional further refinements, the proposed solution may also comprise one or more of the following features:

if the result of the check is yes, the change of the communication connection of the user equipment from the first access network subsystem to the second access network subsystem may be started wherein a message may be sent comprising an information element indicating that the change of the access network subsystem is executed. This information element may comprise a specific cause code;

if the result of the check is no, a message may be sent comprising an information element indicating that the change of the access network subsystem can not be executed, wherein at least one connection parameter allocated to the communication connection of the user equipment to available capabilities of the first access network subsystem may be adapted, and the communication connection of the user equipment at the first access network subsystem may be varied in correspondence with the at least one connection parameter adapted. Again, the information element may comprise a specific cause code, wherein the specific cause code may comprise at least one of a code indicating no coverage of the second access network subsystem, and a code indicating not enough resources of the second access network subsystem;

the adaptation of the at least one connection parameter may comprise a downgrading of the at least one connection parameter to a value achievable by the first access network subsystem;

the at least one connection parameter may comprises a quality of service parameter;

the checking may comprise a judgment whether or not the user equipment is in a coverage area of the second access network subsystem. Optionally, the checking may comprise at least one of a reading of a radio access information and an immediate initiation of the change of the communication connection of the user equipment from the first access network subsystem to the second access network subsystem and observation whether the change of the communication connection is successful. The judgment may further comprise retrieving of a neighbor discovery measurement result in the first access network subsystem, wherein the neighbor discovery measurement result may indicate the presence of an access to the second access network subsystem and a sufficient signal quality achievable with the second access network subsystem;

the mechanism may be applicable in a call setup phase and in an active call phase and the change of the communication connection may be related to the call setup phase or the active call phase;

the second access network subsystem may be of a later generation as the first access network subsystem, in particular may the first access network subsystem be of a second generation cellular network type and the second access network subsystem may be of a third generation cellular network type;

the determination that a change of a communication connection of the user equipment from the first access network subsystem to the second access network subsystem is to be performed may further comprise a receipt of a message from the core network control element at the first access network subsystem wherein that message may comprise an instruction parameter for instructing that the communication connection of the user equipment is to be changed to the second access network subsystem. The instruction parameter may be a cell change order parameter. Also, the message may be received in a connection create message signaling procedure, a connection modify message signaling procedure, or a downlink unitdata message signaling procedure.

By virtue of the proposed solutions, the following advantages can be achieved:

In case a subscriber's user equipment is attached to a first access network subsystem, for example a 2G-access network subsystem, which offers different connection quality or service levels in respective different cells, it is possible to change the access network subsystem to a different one, such as a 3G-access network, when the user equipment's hitherto requested/granted connection quality or service level can not be maintained. For example, when the user equipment enters into another cell providing only a lower service level than the cell from which the user equipment is coming, conventionally the service level would be downgraded in the new cell of the present access network (2G). This can be avoided by changing the communication connection to the access network to the 3G access network side. Thus, a stable service or connection quality level can be provided to a communication connection of a subscriber even during an activated connection so that discomfort for the subscriber or service breakdowns are prevented. In other words, the call success rate with a requested service and/or connection quality level is improved.

The inter-operability between access network subsystems of different service levels and/or development generations is improved since a change of communication connections between these access networks is supported. This is in particular advantageous in situations where a new communication network system (such as a 3G network like UMTS UTRAN) is built up in the vicinity of already existing communication network systems (such as 2G or 2.5G networks). In other words, also a call setup from a system not supporting the service is still successful. This is increasingly important with growing traffic in, for example, a 3G network since more and more 3G capable user equipments requests also service in 2G only environments.

By providing a feedback for the core network control element which has recommended the change of the access network subsystem it is possible to avoid unnecessary signaling and/or processing in the network as a whole. For example, when a change to a 3G access network is possible, it is not necessary that the 2G SGSN performs a PDP context procedure with the user equipment, which is prevented when the 2G SGSN is informed about the change. On the other hand, when the 2G SGSN is informed that such a change of the access network subsystem is not possible but the user equipment is kept attached to the hitherto access network subsystem, necessary adaptations of the service and/or connection quality level for the communication connection can be effected in due time. This is also advantageous in cases where the inter-system cell change is initiated since the operator would prefer the 3G system for providing specific services. In other words, the risk of entering an endless loop of request signaling and timer expiration is eliminated. Thus, the processing load of network elements and the signaling load over the network interfaces is reduced.

The present invention makes it also possible that an inter-system operator is able to move connections (PDP contexts) from one system (like a 2G GSM/EDGE network) to another system (such as a 3G WCDMA system). Hence, a higher flexibility in the management of connections is provided for the operator side which may be useful, for example, in a maintenance case or the like.

The present invention can be easily implemented in the existing network structures since only minor changes in the processing architecture of involved network elements are necessary, while amendments in the user equipment is are not necessary. The signaling mechanisms can be designed such that also in cases where a receiving network element, such as a base station controller or a core network control element (SGSN), is not able to process the received information, the conventional procedures for connection control can be executed without being disturbed.

The above and still further objects, features and advantages of the invention will become more apparent upon referring to the description and the accompanying drawings.

### BRIEF DESCRIPTION OF THE DRAWINGS

FIG. 1 shows a schematic block diagram of a basic network environment of a mobile communication network;

FIG. 2 shows a signaling diagram illustrating a first embodiment of the present invention;

FIG. 3 shows a signaling diagram illustrating a first example of a second embodiment of the present invention;

FIG. 4 shows a signaling diagram illustrating a second example of the second embodiment of the present invention;

FIG. 5 shows a signaling diagram illustrating a first example of a third embodiment of the present invention;

FIG. 6 shows a signaling diagram illustrating a second example of the third embodiment of the present invention; and

FIG. 7 shows a flow chart illustrating a communication connection control method according to the second and third embodiments of the present invention.

### DESCRIPTION OF PREFERRED EMBODIMENTS

In the following, embodiments of the present invention are described with reference to the drawings. For illustrating the present invention, the preferred embodiments will be described in a GPRS network environment comprising 2G and 3G access networks. However, it is to be noted that the present invention is not limited to an application in such a network but is also applicable in other cellular network environments.

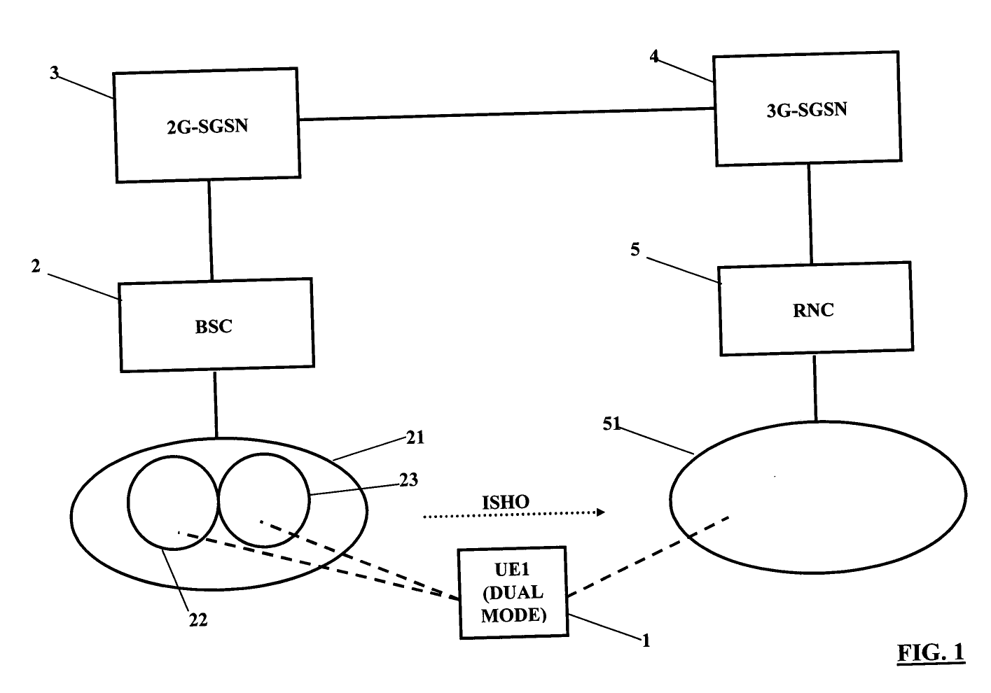

In FIG. 1, a schematic block diagram of a basic network environment of a mobile (cellular) communication network is shown. It is to be noted that the structure according to FIG. 1 represents only a simplified architecture of a cellular communication network environment. As known by those skilled in the art, there are provided several additional network elements and signaling links used for a communication connection. However, for the sake of simplicity, only those elements are depicted which are necessary for describing the invention.

Furthermore, the network elements and their functions described herein may be implemented by software or by hardware. In any case, for executing their respective functions, correspondingly used devices, such as a core network control element like a 2G or 3G SGSN, an access network subsystem element like a BSC or RNC and the like, comprise several means and components (not shown) which are required for control, processing and communication/signalling functionality. Such means may comprise, for example, a processor unit for executing instructions, programs and for processing data, memory means for storing instructions, programs and data, for serving as a work area of the processor and the like (e.g. ROM, RAM, EEPROM, and the like), input means for inputting data and instructions by software (e.g. floppy diskette, CD-ROM, EEPROM, and the like), user interface means for providing monitor and manipulation possibilities to a user (e.g. a screen, a keyboard and the like), interface means for establishing links and/or connections under the control of the processor unit (e.g. wired and wireless interface means, an antenna, etc.) and the like.

According to FIG. 1, the basic network environment of a mobile (cellular) communication network based on the GPRS comprises a terminal device or user equipment (UE) 1, e.g. an MS, a (2G) access network subsystem 21 being controlled by a base station controller (BSC) 2 as an access network subsystem element, and a 2G core network control element like a 2G-SGSN 3. The user equipment 1 is preferably a multi mode terminal device, for example a dual mode terminal device, which is capable to communicate with both 2G and 3G network types, i.e. it is able to change or roam between both network types. The multi mode (e.g. dual mode) capability of the UE 1 may be indicated to the core network side, for example the 2G-SGSN 3, by means of a corresponding parameter signalling (not shown), such as a MS RAC (Mobile Station Radio Access Capability) parameter defined in 3GPP TS 24.008 (V4.14.0). The 2G access network subsystem 21 may include cells (e.g. base stations) having respective different service or connection quality levels such a standard 2G GSM/GPRS cells 23 and a 2G GSM/GPRS/EDGE cell 22 offering also EDGE capability. On the 3G side of the network environment there are provided a 3G access network 51 using, for example, WCDMA access, a Radio Network Controller 5 as an access network subsystem element and a 3G core network control element like a 3G-SGSN 4.

The 2G-SGSN 3 may be connected to the 3G-SGSN 4 via a Gn interface (it is to be noted that some SGSN may comprise both 2G and 3G functionality so that there is no interface necessary). Furthermore, the 2G-SGSN 3 is connected to the 2G access network (i.e. to the BSC 2) via a Gb interface, and the 3G-SGSN 4 is connected to the WCDMA access network (i.e. the RNC 5) via an Iu-ps interface. Thus, a communication connection of the UE 1 may arrive at the 2G-SGSN 3 of the core network via a cell 22 or 23 in the access network subsystem 21, 2 or at the 3G-SGSN 4 via the WCDMA access network subsystem 51, 5.

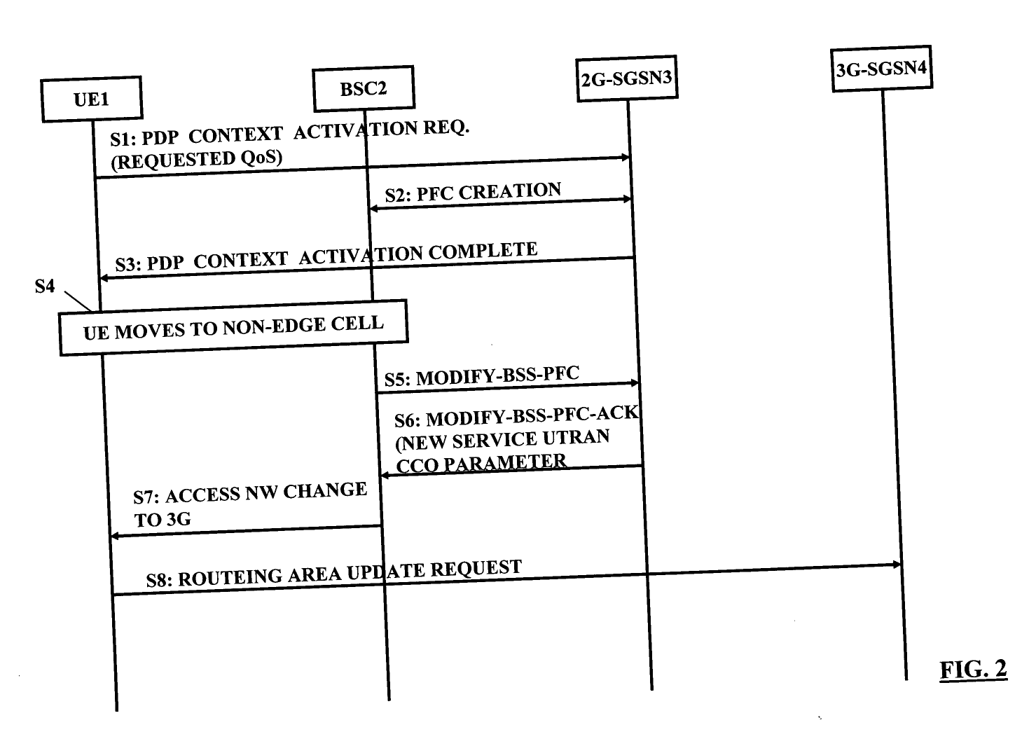

A first embodiment is illustrated in FIG. 2 in connection with FIG. 1. FIG. 2 shows a signaling diagram illustrating a first embodiment of the present invention which is implemented in the network architecture shown in FIG. 1.

The UE 1 located in the cell 22 requests a PDP context activation with a connection parameter, such as a specific QoS level or a high bandwidth, which can be only provided in EDGE cells, like cell 22. For this purpose a PDP context activation request is sent to the core network, i.e. the 2G-SGSN 3 (step S1). The core network control element 2G-SGSN 3 acknowledges this and creates PFC (Packet Flow Context) towards the BSC 2 (step S2). This procedure is known to the skilled person and thus not described in detail herein. After the PFC creation is completed the 2G-SGSN also completes the PDP context activation procedure with the UE (step S3).

Now it is assumed that the UE 1 moves to non-EDGE capable cell like cell 23 which is in the same routeing area RA like the “EDGE” cell 22 (step S4). Here, the initially requested QoS requirements can not be met as the cell 23 (i.e. the corresponding base station) does not have the capabilities necessary for this. The BSC 2, i.e. the processor (not shown) provided in the BSC 2, which controls both cells 22 and 23 informs the 2G-SGSN 3 about this movement by sending, for example, a MODIFY-BSS-PFC message to the 2G-SGSN 3 (step S5). This message comprises information about the maximum QoS, which can (now) be offered to the UE 1. In other words, the BSC 2 starts to modify the previously created PFC (step S2) since the connection parameter or service level for the communication connection of the UE 1 can not be maintained in the “new” cell 23. When the core network CN (i.e. the 2G-SGSN 3) receives the MODIFY-BSS-PFC message (which is specified, for example, in 3GPP TS 48.018) it acknowledges which kind of QoS is possible to provide to the UE 1.

Conventionally, the 2G-SGSN 3 could now only accept the indicated new maximum level of service and downgrade the QoS, or alternatively reject the request (call blocking).

According to the present embodiment, in a situation where the UE 1 enters a cell not able to maintain the hitherto service level, a Core Network ordered access change mechanism is executed. By means of this the UE 1 is (virtually) moved to another access network, like a 3G-WCDMA access network, where the requested QoS requirement can be met. It is to be noted that the 2G-SGSN does not have any knowledge regarding the specific EDGE radio network configuration since EDGE cell information is not provided to the CN. In the example shown in FIG. 2, after receiving the MODIFY-BSS-PFC message in step S5, the mechanism is triggered in the 2G-SGSN 3 by the indication that a downgrade of the service level is necessary. Instead of the indication of downgrading also other modifications in the communication connection could be set as a trigger for the mechanism which can be chosen, for example, by the network operator.

The Core Network ordered access change to a second access network subsystem is effected by answering the message indication the need for the modification of the communication connection of the UE 1 with a message comprising an instruction parameter for instructing that the communication connection of the user equipment is to be changed to the second access network subsystem being determined to having the capability to provide the (hitherto requested) connection parameter.

In the present embodiment the 2G-SGSN 3, i.e. a processor (not shown) installed in the 2G-SGSN 3, orders, for example, an access change to WCDMA. This is achieved by introducing a Service UTRAN CCO (Cell Change Order) parameter, which is specified in 3GPP TS 48.018, in the reply message to the MODIFY-BSS-PFC message, i.e. the MODIFY-BSS-PFC-ACK message (step S6). The Service UTRAN CCO parameter indicates to the BSC 2 one of the following information:
Network initiated cell change order procedure to UTRAN should be performed
Network initiated cell change order procedure to UTRAN should not be performed
Network initiated cell change order procedure to UTRAN shall not be performed.

In the present case, the BSC 2 is instructed (or recommended) to perform a cell change (access network subsystem change) of the UE 1 communication connection to the 3G side, i.e. to the WCDMA access network 51, 5.

The BSC 2, i.e. its processor, follows this order and effects an access change of the UE 1 to the 3G side (step S7). In reaction to this, the UE 1 requests access to the 3G network, for example, by means of a routeing area update request to the 3G-SGSN 4 (step S8) routeing area update. Thereafter, the communication connection level of the UE 1 can be maintained as originally established.

With the connection control mechanism described above, it is possible that a subscriber's service level remains and a requested service level or connection parameter, like the QoS, can be offered without the need of downgrading (in the 3G-access). Furthermore, the interoperability between different access networks, like the interoperability between GSM/EDGE/WCDMA, can be improved.

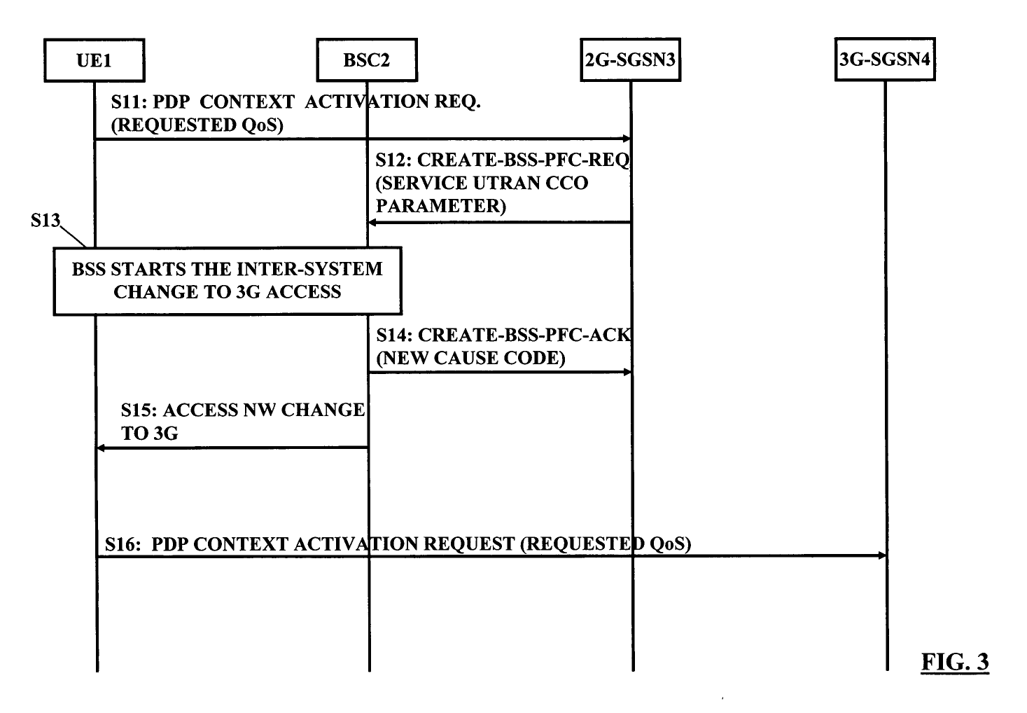

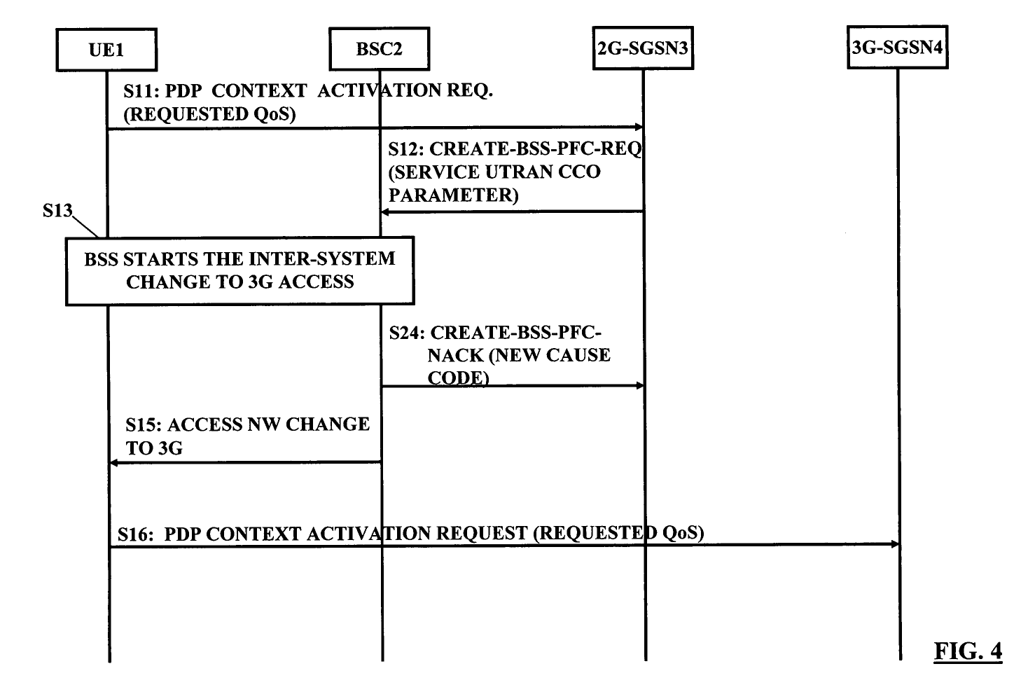

Now, referring to FIGS. 3 and 4 in connection with FIG. 1, a second embodiment of the present invention is described. FIGS. 3 and 4, respectively, show signaling diagrams illustrating a first and second example of the second embodiment of the present invention.

In the situation according to the second embodiment, it is assumed that the UE1 is located in a cell of the first access network subsystem 21, 2, specifically in a cell having lower service level capability than another cell. The UE 1 tries to set-up a communication connection with a service level (i.e. a connection parameter) which can not be provided by the cell it is located. For example, the UE 1 is in the non-EDGE capable cell 23 and requests a PDP context activation with QoS, which can be only provided in EDGE cells (or in 3G) (step S11). The core network control element, e.g. the 2G-SGSN 3, acknowledges this request and recognizes that the requested service level is not available at the cell 23. Then, the 2G-SGSN 3 creates a signalling connection, like a PFC, towards the BSC 2 (step S12). The creation of PFC is done, for example, with a CREATE-BSS-PFC Request message. The message sent from the 2G-SGSN 3 comprises an indication element that a access change is to be performed, such as a Service UTRAN CCO parameter.

In step S13, the BSC 2 determines from the received message of the 2G-SGSN 3 that a change of the access network is instructed or recommended. Therefore it starts the inter-system handover (ISHO) procedure by checking whether or not the access change is executable. For example, it is detected whether a 3G access, where the requested service level can be provided, is in range of the user equipment 1, for example on the basis of a neighbor discovery measurement. If it is judged that the UE 1 is in the coverage area of a 3G access network, such as the access network 51 in FIG. 1, the BSC 2 and the UE 1 agrees that an access change can be made.

In step S14, after having judged that the access network change as instructed by the core network control element is executable, the BSC 2 responds to the instructing message from the 2G-SGSN 3 with a corresponding reply message. According to the example shown in FIG. 3, the reply message to the CREATE-BSS-PFC Request message (step S12) can be a CREATE-BSS-PFC-ACK message (step S14).

Conventionally, the BSC 2 can answer to a CREATE-BSS-PFC Request message either with CREATE-BSS-PFC-ACK message including a modified/downgraded ABQP (Aggregate BSS QoS Profile) or a CREATE-BSS-PFC-NACK (non-acknowledgement) message, the latter will be discussed in connection with FIG. 4. As the 2G-SGSN 3 has introduced a Service UTRAN CCO parameter to the CREATE-BSS-PFC Request message, which tells BSC 2, for example, that a network initiated cell change order procedure to UTRAN should be performed information the BSC 2 starts with the access change procedure as described in step S13. However, when the SGSN receives such a CREATE-BSS-PFC-ACK message it normally starts a PDP context modification procedure for the communication connection of the UE 1.

According to the present embodiment, the BSC 2, i.e. the processor thereof, knows that the access change procedure of the UE 1 is executed. For this reason, an information element is introduced in the message replying to the instruction message of the core network control element instructing the access change. In this example, a new cause code parameter, for example, an information indicating “access change to 3G”, is included in the CREATE-BSS-PFC-ACK message which is sent to the 2G-SGSN 3 (step S14). This information element, i.e. the cause code informs the 2G-SGSN 3, i.e. its processor, that the UE 1 is moving to the second access network, i.e. the 3G access, so that a PDP context modification procedure is not necessary (modifications of PDP contexts are not needed), and the 2G-SGSN 3 omits the execution thereof.

Then, in step S15, the BSC 2 instructs the UE 1 to execute the access network change, for example from the 2G access network subsystem 21, 2 to the 3G access network subsystem 51, 5 (WCDMA) where the requested service level is achievable. In the following, the UE 1 executes a PDP context activation request procedure with the hitherto service or connection quality level parameter(s) at the 3G-SGSN 4 via the access network subsystem 51, 5 (RNC) (step S16).

In other words, there is provided a mechanism by means of which the BSS acknowledges the core network initiated cell change order procedure to the core network. Due to this acknowledgement, a PDP context modification towards GGSN/UE after receiving the CREATE-BSS-PFC-ACK message, which would normally started by the SGSN, is prevented.

In FIG. 4, a similar mechanism like that described in connection to FIG. 3 is shown. Here, same reference signs denote same or equivalent steps.

In difference to the mechanism according to FIG. 3, the present embodiment according to the example shown in FIG. 4 uses a CREATE-BSS-PFC-NACK message into which, similar to the above described CREATE-BSS-PFC-ACK message of FIG. 3, an information element, such as a cause code parameter indicating “access change to 3G”, is included in the CREATE-BSS-PFC-NACK message which is sent to the 2G-SGSN 3 (step S24). This information element, i.e. the cause code informs the 2G-SGSN 3, i.e. its processor, that the UE 1 is moving to the second access network, i.e. the 3G access, so that a PDP context modification procedure is not necessary (modifications of PDP contexts are not needed), and the 2G-SGSN 3 omits the execution thereof. In other words, according to the present embodiment, the NACK message, which is used to indicate an unsuccessful PFC creation in the 2G system, is now used to inform the 2G-SGSN 3 that the ISHO to the 3G network is performed.

By means of the mechanism described in the second embodiment according to FIGS. 3 and 4, the signalling and processing load in the network, in particular with regard to the core network control element, such as the 2G-SGSN, can be reduced since an unnecessary PDP context modification procedure is avoided. This is achieved by indicating to the 2G-SGSN that for the communication connection of the UE 1 an access change is executed. Furthermore, the interoperability of networks of different types, such as a GSM/EDGE/WCDMA inter-operability, can be improved. Moreover, inter-system operators could use this mechanism if they wish to move all PDP contexts to another system, e.g. to WCDMA.

It is to be noted that the procedure of the second embodiment is applicable to the control of communication connections in different phases, i.e. during a connection set-up phase, an active connection phase and the like, or in different network types as long as the core network control element can be informed by any message type and parameter about the execution of the access network change.

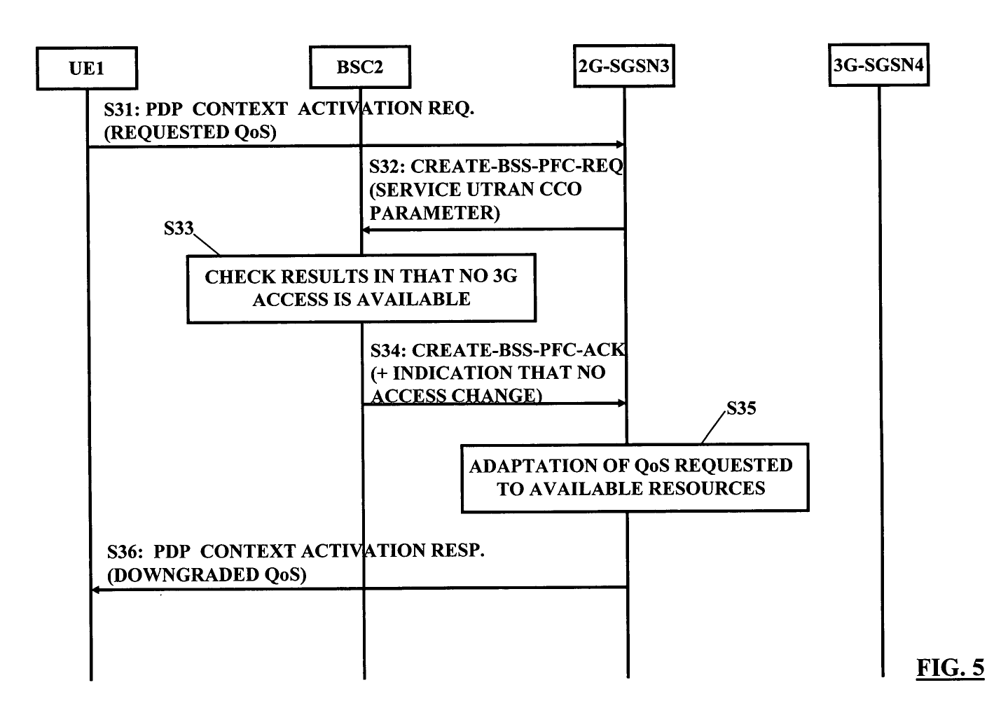

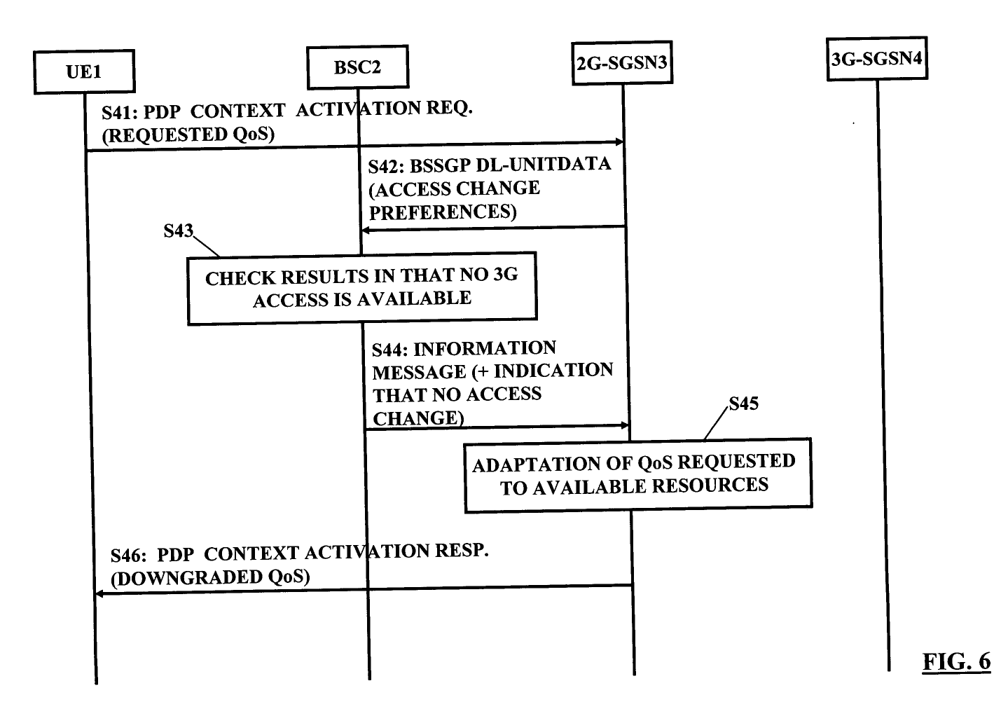

Now, a third embodiment of the present invention is described in connection with FIGS. 5 and 6 as well as FIG. 1.

In the third embodiment, a situation similar to that of the second embodiment can be assumed. This means, for example, that there is a packet switched (PS) connection of the user equipment UE 1 in a communication system. The connection may either be already established or in the process of being set up (indicated by step S31 (PDP context activation request) in FIG. 5). Furthermore, there is a situation that the core network control element, such as the 2G-SGSN 3, recommends to the radio controller (e.g. BSC 2) a cell change of the UE 1 connection to another cell or access network, e.g. a cell change from 2G (GPRS) to 3G (WCDMA). The BSC 2 generally follows this recommendation and gives to the user equipment (mobile) UE 1, for example, a packet cell change order (PCCO).

According to FIG. 5, the instruction or recommendation to change the cell is given to the BSC 2 by means of a specific message, for example a CREATE-BSS-PFC-Request message (step S32). The CREATE-BSS-PFC-Request comprises a corresponding instruction parameter such as a Service UTRAN CCO parameter for advising the access change.

However, there are situations where the access change is not possible, e.g. because the UE 1 is not in the coverage area of a 3G access. In this situation, the connection has to remain in the hitherto (first) access network, i.e. in the 2G access network.

It may arise a situation in the call setup if the requested PS call cannot be supported in the current system. Namely, if the UE 1 requests, for example, a streaming call with 128 kbps in 2G (GPRS) and the 2G-SGSN 3 recognizes that the request can not be supported, the SGSN 3 might not reply to the service request (i.e. keeps the UE 1 waiting for the response) but recommends to the BSC 2 a cell change to 3G (as executed in step S32). Now, the BSC 2 checks whether or not a cell change as recommended is possible, for example, by using neighbour cell measurements. From that it recognizes that the UE 1 is not in a 3G coverage area. This is indicated in FIG. 5 in step S33. Another scenario for the above mentioned situation is, for example, that the UE 1 is in the coverage area of the 3G network but for some reason, such as congestion, the PCCO to the 3G network is not successful.

Conventionally, neither the BSC nor the SGSN would perform a further processing. In particular the SGSN is not aware that the UE 1 can not attach to the 3G network. Therefore, an endless loop of requests (after expiration of a timer) may occur.

According to the present embodiment, a feedback from the (first) access network subsystem, i.e. the BSC 2, to the core network control element recommending the cell change, i.e. the 2G-SGSN 3 over the Gb interface is provided. It is to be noted that the interface type may also be a different one in another application environment, for example an Iu interface. This feedback is used to indicate that a PCCO is not possible or was not successful. This is indicated in FIG. 5 by step S34, for example by means of a corresponding cause code parameter which may indicate, in dependence of the reason for the unsuccessful PCCO, for example “no coverage of the second access network subsystem”, “not enough resources of the second access network subsystem”, or the like. It is to be noted that the access network subsystem element, e.g. the BSC 2, may also notify the core network control element (SGSN) about a successful PCCO and that the PCCO command has been given or been successful.

This means that the BSC 2 informs the 2G-SGSN by means of a message including an information element that the access change is not possible. Now the core network control element is able to proceed with the connection of the UE 1 in a suitable manner. For example, as indicated in step S35, the connection parameter requested for the communication connection of the UE 1 is adapted in accordance with the capabilities provided by the 2G access network. This means, for example, that the 2G-SGSN 3 downgrades the requested QoS, e.g. to a transmission rate of 64 kbps, and suggests this new connection parameter to the UE 1 (step S36), for example by means of a PDP context activation response message. The UE 1 can now decide whether or not the suggested (and available) service level is acceptable, and proceeds accordingly.

There are at least two options for signalling between the core network control element and the access network subsystem element for the access network change procedure. The first one is shown in FIG. 5 where a BSSGP CREATE-BSS-PFC signalling is used. This means that the SGSN 3 sends a CREATE-BSS-PFC-REQUEST in step S32 for instructing the access change. This message is acknowledged with a CREATE-BSS-PFC-ACK message by the BSC 2 in step S34. The indication of inter-system handover ISHO non-success (or success) is carried to the core network (i.e. the SGSN) in this message.

In FIG. 6, which illustrates a second example of the third embodiment, another signalling option between the core network control element and the access network subsystem element for the access network change procedure is used. While in the first example according to FIG. 5 the BSSGP CREATE-BSS-PFC signalling is used, the second example uses a BSSGP DL-UNITDATA (downlink) signalling to convey the access change preference from the core network control element (SGSN 3) to the access network subsystem, i.e. the BSS (step S42). In response to the DL-UNITDATA, the BSC 2 sends a corresponding information message to indicate that a PCCO is not possible or was not successful. Regarding the information message to be used to indicate the impossible or unsuccessful PCCO it is to be noted that an uplink unitdata (UL UNITDATA) signalling is hardly usable for this purpose. The reason is that by definition UL UNITDATA comprises always an LLC PDU (logical link control protocol data unit) which usually can not be constructed by the BSS since the LLC protocol is not implemented in the BSC, or the BSC is not able to cipher the LLC PDU properly even if the BSC is adapted to construct it. Therefore, it is preferable to use another (novel) BSSGP protocol signalling message from the BSC to the SGSN. This signalling message may be defined as a Service-CCO-Status, for example, and comprise a cause code indicating either the success or, in the present example of the impossible or unsuccessful PCCO, a failure cause, such as “congestion”, “coverage not available” and the like in case the BSC determines that the access change can not be performed.

It is to be noted that the remaining steps of FIG. 6, i.e. steps S41, S43, S45 and S46 are similar or equivalent to corresponding steps S31, S33, S35 and S36 in FIG. 5 so that a detailed description thereof is omitted here.

In general, according to the third embodiment, it is acknowledged to the core network control element if the access change has not been successful. For example if the UE returns back to 2G, the BSC informs the SGSN about an access change failure. Thus, the connection can be kept in the 2G network in an appropriate manner.

As mentioned above, the third embodiment is applicable not only in the call setup phase but also in an active call situation where the user equipment is moved to another cell with lower capability than the former cell.

It is to be noted that the present invention is not limited to a MOC (Mobile Originated Call) scenario where the service request is made by the calling side user equipment, but is equivalently applicable in a MTC (Mobile Terminating Call) scenario where the service request which initiates the cell change of the user equipment comes from the called party which may be another mobile station, a server and the like.

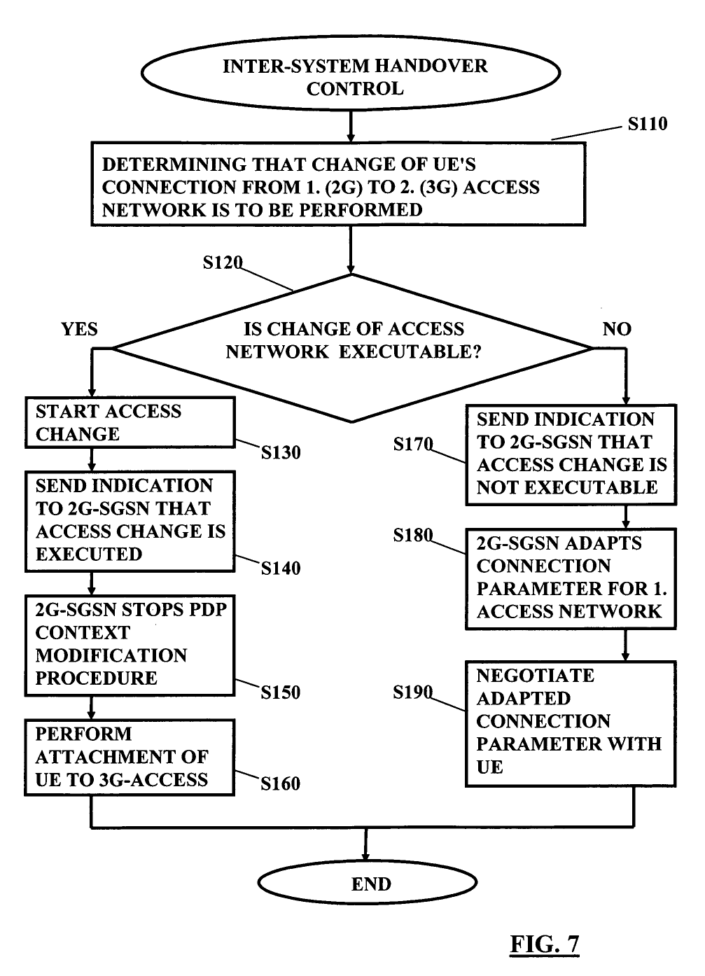

In FIG. 7, a flow chart illustrating a communication connection control method according to the second and third embodiments of the present invention, i.e. for a method for the inter-system handover control, is shown.

In step S110 it is determined that a change of the connection of a user equipment or mobile unit from a first access network (e.g. 2G) to a second access network (e.g. 3G) is to be performed, for example due to an instruction given by the core network (SGSN). Then, in step S120, it is checked whether or not an access change is possible, for example whether or not the UE is in the coverage area of the second access network subsystem. This check may be based, for example, on reading of specific information in the radio access (neighbor list) or on a neighbor cell discovery measurement. The neighbor discovery measurement result indicates preferably that there exists a neighbor (i.e. the UE 1 is in the coverage area) and that the neighbor can provide a sufficient signal quality. Alternatively, it is also possible to immediately execute the cell change for the UE 1 and to observe whether or not the cell change succeeds.

The steps S110 and S120 may be performed, for example, by a processor of a access network subsystem element like the BSC.

If the result of step S120 is positive (YES), i.e. the access change is possible, step S130 is executed in which the access change of the UE's connection from the first access network subsystem to the second access network subsystem is started. In step S140, an indication of the access change execution is given to the core network control element. The core network control element may then stop connection modification procedures with the UE, like a PDP context modification procedure (step S150). In step S160, the attachment of the UE to the second access network subsystem is completed.

On the other hand, if the result of step S120 is negative (NO), i.e. the access change is not possible (or not successful), step S170 is executed in which this result is indicated to the core network control element, for example by means of a corresponding cause code parameter which may indicate, in dependence of the reason for the unsuccessful PCCO, for example “no coverage of the second access network subsystem”, “not enough resources of the second access network subsystem”, or the like. In step S180, the core network control element executes a procedure so as to enable to maintain the connection of the UE within the first access network subsystem. This comprises, for example, an adaptation of requested connection parameters to the capability of the first access network subsystem. In step S190, the adapted connection parameter is then negotiated with the UE, and the connection can be established/kept or terminated in the first access network subsystem.

After both steps S160 and S190 the method for the inter-system handover control ends.

Even though the above first to third embodiments are described in connection with an access network an core network control element of the 2nd generation (GSM/GPRS/EDGE), it is to be noted that the described mechanisms are also applicable in other network types, such as a 3rd generation network in connection with the respective network elements (RNC, 3G-SGSN and the like).

As mentioned above, the present invention is applicable in both cases that the service request which initiates the cell change of the user equipment comes from the user equipment itself (MOC scenario) or from the called party (MTC scenario).

As described above, there is proposed a mechanism for controlling a communication connection of a user equipment in a communication network. The communication network comprises at least a core network subsystem having at least one core network control element, and a first access network subsystem and at least a second access network subsystem. On one hand, when it is detected that at least one connection parameter of a communication connection of the user equipment can not be maintained by the first access network subsystem, a connection modification message is sent to the core network control element. The core network control element responds with an acknowledgement message the acknowledgement message comprising an instruction parameter for instructing that the communication connection of the user equipment is to be changed to the second access network subsystem being determined to having the capability to provide the connection parameter. On the other hand, when a change of a communication connection of the user equipment from the first access network subsystem to the second access network subsystem is to be performed, it is checked whether or not the cell change is executable. On the basis of the result of the checking step, a message is sent to the core network control element comprising an information element about the execution of the change of the access network subsystem.

It should be understood that the above description and accompanying figures are merely intended to illustrate the present invention by way of example only. The preferred embodiments of the present invention may thus vary within the scope of the attached claims.

1. A method of controlling a communication connection of a user equipment in a communication network, wherein the communication network comprises at least a core network subsystem having at least one core network control element, and a first access network subsystem and at least a second access network subsystem,
the method comprising steps of:
detecting that at least one connection parameter of a communication connection of the user equipment is excluded from being maintained by the first access network subsystem or is unintended to be maintained for the communication connection;
sending a connection modification message indicating a result of the detecting step from the first access network subsystem to the core network control element; and
transmitting an acknowledgement message in response to the connection modification message from the core network control element to the access network subsystem,
wherein the acknowledgement message comprises an instruction parameter that instructs the communication connection of the user equipment to change to the second access network subsystem being determined to have a capability to provide the at least one connection parameter.

2. The method according to claim 1, further comprising a step of determining in the core network control element based on the connection modification message that the at least one connection parameter can be provided by the second access network subsystem.

3. The method according to claim 1, further comprising the steps of:
sending upon the receipt of the acknowledgement message an instruction message from the first access network subsystem to the user equipment to execute a change to the second access network subsystem,
performing an inter-system handover by requesting an establishment of a communication connection including the at least one connection parameter at the second access network subsystem.

4. The method according to claim 1, wherein the at least one connection parameter is a quality of service parameter.

5. The method according to claim 1, wherein the instruction parameter is a cell change order parameter.

6. The method according to claim 1, wherein the second access network subsystem is of a later generation as the first access network subsystem, in particular is the first access network subsystem is a second generation cellular network and the second access network subsystem is a third generation cellular network.

7. The method according to claim 6, wherein the core network control element is a service General Packet Radio System (GPRS) support node.

8. The method according to claim 1, wherein the at least one connection parameter of the communication connection of the user equipment is requested and/or granted in a first cell section of the first access network subsystem, which cell section offers different connection capabilities than another cell section of the first access network subsystem to which the user equipment is moving.

9. The method according to claim 8, wherein the first cell section of the first access network subsystem comprises an Enhanced Data Rate for Global Evolutions (EDGE) capability and the second access network subsystem comprises wide band code division multiple access (WCDMA) capability.

10. The method according to claim 1, further comprising a step of informing the core network control element about an execution of a user equipment's change to the second access network subsystem.

11. A method of controlling a communication connection of a user equipment in a communication network, wherein the communication network comprises at least a core network subsystem having at least one core network control element, and a first access network subsystem and at least a second access network subsystem,
the method comprising steps of:
determining that a change of a communication connection of the user equipment from the first access network subsystem to the second access network subsystem is to be performed;
checking whether the change of the communication connection of the user equipment from the first access network subsystem to the second access network subsystem is executable; and
sending, based on a result of the checking step, a message to the core network control element comprising an information element about execution of the change of the access network subsystem from the first access network subsystem to the second access network subsystem.

12. The method according to claim 11, wherein, if the result of the checking step is yes,
starting the change of the communication connection of the user equipment from the first access network subsystem to the second access network subsystem, and
wherein the sending step includes a step of sending a message comprising an information element indicating that the change of the access network subsystem is executed.

13. The method according to claim 12, wherein the information element comprises a specific cause code.

14. The method according to claim 11, wherein, if the result of the checking step is no,
the sending step includes a step of sending a message comprising an information element indicating that the change of the access network subsystem can not be executed, and
the method further comprises steps of: adapting at least one connection parameter allocated to the communication connection of the user equipment to available capabilities of the first access network subsystem,
varying the communication connection of the user equipment at the first access network subsystem in correspondence with the at least one connection parameter adapted.

15. The method according to claim 14, wherein the information element comprises a specific cause code.

16. The method according to claim 15, wherein the specific cause code comprises at least one of a code indicating no coverage of the second access network subsystem, and a code indicating not enough resources of the second access network subsystem.

17. The method according to claim 14, wherein the step of adapting the at least one connection parameter comprises a step of downgrading the at least one connection parameter to a value achievable by the first access network subsystem.

18. The method according to claim 14, wherein the at least one connection parameter comprises a quality of service parameter.

19. The method according to claim 11, wherein the step of checking comprises a step of judging whether the user equipment is in a coverage area of the second access network subsystem.

20. The method according to claim 11, wherein the step of checking comprises at least one of a step of reading a radio access information and a step of initiating immediately the change of the communication connection of the user equipment from the first access network subsystem to the second access network subsystem and observing whether the change of the communication connection is successful.

21. The method according to claim 19, wherein the step of judging comprises a step of retrieving a neighbor discovery measurement result in the first access network subsystem.

22. The method according to claim 21, wherein the neighbor discovery measurement result indicates a presence of an access to the second access network subsystem and a sufficient signal quality achievable with the second access network subsystem.

23. The method according to claim 11, wherein the method is applicable in a call setup phase and in an active call phase and the change of the communication connection is related to the call setup phase or the active call phase.

24. The method according to claim 11, wherein the second access network subsystem is of a later generation as the first access network subsystem.

25. The method according to claim 11, wherein the step of determining that a change of a communication connection of the user equipment from the first access network subsystem to the second access network subsystem is to be performed further comprises a step of receiving a message from the core network control element at the first access network subsystem that message comprising an instruction parameter for instructing that the communication connection of the user equipment is to be changed to the second access network subsystem.

26. The method according to claim 25, wherein the instruction parameter is a cell change order parameter.

27. The method according to claim 25, wherein the message is received in a connection create message signaling procedure, a connection modify message signaling procedure, or a downlink unitdata message signaling procedure.

28. The method according to claim 11, wherein the change of the communication connection of the user equipment from the first access network subsystem to the second access network subsystem comprises:
detecting that at least one connection parameter of a communication connection of the user equipment is excluded from being maintained by the first access network subsystem or is unintended to be maintained for the communication connection;
sending a connection modification message indicating a result of the detecting step from the first access network subsystem to the at least one core network control element,
transmitting an acknowledgement message in response to the connection modification message from the at least one core network control element to the access network subsystem;
wherein the acknowledgement message comprises an instruction parameter that instructs the communication connection of the user equipment to change to the second access network subsystem being determined to having the capability to provide the connection parameter.

29. A system for controlling a communication connection of a user equipment in a communication network, wherein the communication network comprises at least a core network subsystem having at least one core network control element, and a first access network subsystem and at least a second access network subsystem,
the system comprising:
detecting means for detecting that at least one connection parameter of a communication connection of the user equipment is excluded from being maintained by the first access network subsystem or is unintended to be maintained for the communication connection;
sending means for sending a connection modification message indicating a result of the detecting means from the first access network subsystem to the core network control element;
transmitting means for transmitting an acknowledgement message in response to the connection modification message from the core network control element to the access network subsystem; and
wherein the transmitting means introduces into the acknowledgement message an instruction parameter for instructing that the communication connection of the user equipment is to be changed to the second access network subsystem being determined to having a capability to provide the at least one connection parameter.

30. The system according to claim 29, further comprising determining means in the core network control element for determining, based on the connection modification message that the at least one connection parameter can be provided by the second access network subsystem.

31. The system according to claim 29, further comprising
means in the first access network subsystem for generating and sending, upon receipt of the acknowledgement message, an instruction message to the user equipment to execute a change to the second access network subsystem; and
means in the user equipment for performing an inter-system handover by requesting an establishment of a communication connection including the at least one connection parameter at the second access network subsystem.

32. A system of controlling a communication connection of a user equipment in a communication network, wherein the communication network comprises at least a core network subsystem having at least one core network control element, and a first access network subsystem and at least a second access network subsystem,
the system comprising:
means in the first access network subsystem for determining that a change of a communication connection of the user equipment from the first access network subsystem to the second access network subsystem is to be performed;
means in the first access network subsystem for checking whether the change of the communication connection of the user equipment from the first access network subsystem to the second access network subsystem is executable; and
means in the first access network subsystem for sending, based on the result of the means for checking, a message to the core network control element comprising an information element about execution of the change of the access network subsystem.

33. The system according to claim 32, wherein, if the result of the checking means is yes,
the first access network subsystem comprises means for starting the change of the communication connection of the user equipment from the first access network subsystem to the second access network subsystem, and
wherein the means for sending is configured to send a message comprising an information element indicating that the change of the access network subsystem is executed.

34. The system according to claim 32, wherein, if the result of the checking means is no,
the means for sending is configured to send a message comprising an information element indicating that the change of the access network subsystem can not be executed,
wherein the at least one core network control element further comprises means configured to adapt at least one connection parameter allocated to the communication connection of the user equipment to available capabilities of the first access network subsystem, and
the first access network subsystem comprises means configured to vary the communication connection of the user equipment at the first access network subsystem in correspondence with the at least one connection parameter adapted.

35. A core network control element usable for controlling a communication connection of a user equipment in a communication network, wherein the communication network comprises at least a core network subsystem having at least the core network control element, and a first access network subsystem and at least a second access network subsystem,
the core network control element comprising:
a processor configured to receive and process a connection modification message indicating that at least one connection parameter of a communication connection of the user equipment can not be maintained by the first access network subsystem or is not intended to be maintained for the communication connection,
the processor being further configured to generate and transmit to the first access network subsystem an acknowledgement message in response to the connection modification message,
wherein the processor introduces in the acknowledgement message an instruction parameter for instructing that the communication connection of the user equipment is to be changed to the second access network subsystem being determined to have a capability to provide the at least one connection parameter.

36. The core network control element according to claim 35, wherein the processor is further configured to determine based on the connection modification message, that the connection parameter can be provided by the second access network subsystem.

37. An access network subsystem element usable in controlling a communication connection of a user equipment in a communication network, wherein the communication network comprises at least a core network subsystem having at least one core network control element, and a first access network subsystem comprising the access network subsystem element and at least a second access network subsystem,
the access network subsystem element comprising:
a processor configured
to determine that a change of a communication connection of the user equipment from the first access network subsystem to the second access network subsystem is to be performed,
to check whether a change of the communication connection of the user equipment from the first access network subsystem to the second access network subsystem is executable, and
to send, based on a result of the check, a message to the core network control element comprising an information element about execution of the change of the access network subsystem.

38. The access network subsystem element according to claim 37, wherein, if the result of the processor's check is yes, the processor is further configured
to start the change of the communication connection of the user equipment from the first access network subsystem to the second access network subsystem, and
wherein the processor is configured to send a message to the core network control element comprising an information element indicating that the change of the access network subsystem is executed.

39. The access network subsystem element according to claim 37, wherein, if the result of the processor's check is no,
the processor is configured
to send a message to the core network control element comprising an information element indicating that the change of the access network subsystem can not be executed,
to receive, from the core network control element, information comprising at least one adapted connection parameter allocated to the communication connection of the user equipment to available capabilities of the first access network subsystem, and
to vary the communication connection of the user equipment at the first access network subsystem in correspondence with the at least one connection parameter adapted.
